(19) United States
(12) Patent Application Publication
(10) Pub. No.: US 2007/0151428 A1
(43) Pub. Date: Jul. 5, 2007

(54) Woodturning Tool

(75) Inventor: Michael L. Hunter, Minneapolis, MN (US)

Correspondence Address: INTELLECTUAL PROPERTY GROUP;FREDRIKSON & BYRON, P.A., 200 SOUTH SIXTH STREET, SUITE 4000, MINNEAPOLIS, MN, 55402, US

(73) Assignee: WHALEY MARKETING COMMUNICATIONS, INC., Eden Prairie, MN (US)

(21) Appl. No.: 11/618,930

(22) Filed: Jan. 1, 2007

Related U.S. Application Data
(60) Provisional application No. 60/755,139, filed on Dec. 30, 2005.

(51) Int. Cl. B23B 3/00; B26D 1/00

(52) U.S. Cl. 82/1.11; 142/56; 407/104

(57) ABSTRACT

A woodworking lathe tool adapted to receive a replaceable, indexable carbide cutting insert. A screw or other fastening means may be employed to releasably fasten a cutting insert, including at least a carbide portion, to the distal end of a tool shank. The tool allows the user to quickly release and index the cutting insert and continue using it as before, extending the useful life of the carbide insert. When all cutting surfaces have been worn, the insert can be replaced, eliminating the inconvenience and cost associated with sharpening tools.

### CROSS REFERENCE TO RELATED APPLICATIONS

This invention claims priority to U.S. Provisional Patent Application Ser. No. 60/755,139, filed on Dec. 30, 2005, the contents of which are incorporated by reference.

### FIELD

The invention relates generally to a woodworking lathe tool, and more particularly, to a handheld woodworking lathe tool having replaceable, indexable tips.

### BACKGROUND

Hobbyists and woodworking professionals use tools, such as chisels and gouges, to shape wooden workpieces as they turn on a lathe. The tools typically have a handle, for comfortable handheld use, and a metal member that extends from the handle and terminates in a shaped tip.

During normal use, the shaped tip of the metal member frequently becomes dull and must be repeatedly re-shaped or sharpened before continued use. In this manner, the shaped tip eventually wears down in length after repeated sharpenings, until the entire metal member itself must be replaced. The need to repeatedly sharpen tools poses an inconvenience to the user due to the interruption of work, as well as an expense due to the equipment and time needed to shape and sharpen these tools.

Many processes for shaping wood or other materials involve the removal of material by cutting or similar operations. The tools generally used by home and production lathe shops are made of special steels such as tool steels (e.g., M2) or powdered metals (e.g., PM). Turning and boring tools are available in a wide range of shapes and styles. These tools are commonly known as radius skew, radius scraper, spear point, parting tool, bowl gouge, spindle gouge, roughing gouge, detail gouge, etc. All of these tools need to be continuously re-sharpened and re-honed as they wear through normal use.

Most of the above-mentioned tools are used for outer diameter (OD) turning or inner diameter (ID) boring. An example of OD turning may occur when forming and/or shaping the outside of a wooden bowl. Typical examples of ID boring may include turning and shaping the inside of a wooden bowl or turning the inside diameter of a wooden pencil cup. Generally, the wood turning tool has a handle or shaft connected to the tool blank. The tool blank is ground or sharpened to meet a variety of specific needs of the wood turner operator.

In recent years, small carbide inserts (e.g., typically having a screw-on fastening geometry) have been used in certain metal cutting operations. These machining operations utilize turning tool holders or boring bars to hold the carbide inserts. These holders and bars may lock and secure the insert using a Torx® screw. These holders and bars may be held onto the machine by use of a turret (e.g., in CNC operations), or by use of a tool post (e.g., in manual operations). The most common use of these metal cutting holders and bars is in the application of “Swiss type” screw machines or in “near net-shape” part machining.

Toolholders or boring bars typically used in existing metal cutting operations may not be appropriate for manual wood cutting operations, since they cannot be safely held by hand, for example, in home or small lot production wood turning operations.

### SUMMARY

Certain embodiments of the invention include a hand-held woodturning lathe tool adapted to receive a replaceable, indexable carbide tip. The tool may include a longitudinal shank, and may incorporate a set screw or other fastening means to fasten a carbide cutting insert (or carbide-tipped cutting insert) to the distal end of the shank. The carbide insert is designed to last much longer than existing wood turning tools. The invention also extends to the indexable nature of the tip, which allows a user to quickly release and rotate the tip, presenting a new cutting surface for continued use, thereby extending the useful life of the cutting insert. When all cutting surfaces have been worn, the tip can be easily and cost-effectively replaced, eliminating the inconvenience and cost associated with sharpening tools. In certain embodiments of the invention, the cutting insert may employ a symmetrical design that allows reversing the cutting insert, effectively doubling the useful life of the cutting insert.

Certain embodiments of the invention provide an indexable cutting insert mounted on the tool shank with a fastening screw. In some embodiments, a fastening screw having an internal star-shaped head (e.g., a screw having a hexalobular internal driving feature, such as a Torx® screw) may be used to secure the indexable cutting insert to the tool shank. (A Torx® screw is a screw or bolt that has a special star-shaped pattern in the head, similar to an Allen screw, and requires a specific type of screwdriver or socket to remove. The design may allow for more torque to be put on the head without stripping.) The cutting insert and tool shank assembly are fastened to a tool handle adapted to be held by a woodturning operator. The indexable cutting insert may have several shapes and forms. They are known as DCMT style, VBMT style, RCMT style, grooving style, and threading style, and may be chosen and utilized as job requirements are specified. The indexable inserts may be mounted to the tool shanks with appropriately-sized screws, the shanks then being secured to tool handles, which may be sized to the individual operator's needs.

The indexable cutting insert, shank, and handle may be selected by the woodturning operator (e.g., based on size, shape, and other parameters). The operator's requirements may change based on the task or the particular machine being utilized.

As the indexable inserts wear down (e.g., through normal use), the fastening screw may be removed, thereby allowing the insert to be repositioned (i.e., “indexed”) to allow the use of a new cutting edge (e.g., a new or unused corner of the insert). Repositioning or indexing typically involves rotating the cutting insert relative to the tool shank to present a new cutting surface for woodturning. In embodiments having two useable cutting surfaces, for example, indexing the cutting insert might involve rotating the insert approximately 180 degrees (e.g., about an axis aligned with the fastening screw). Other embodiments could employ 3, or 4, or more useable cutting surfaces, which might entail rotating the insert approximately 120 degrees, or 90 degrees, or some other amount, respectively, to present a new or different cutting surface. A new (or different) working edge is thus exposed and ready for use by the woodturning operator with no need for sharpening of the tool. Once all of the useful cutting edges (or corners) have been worn sufficiently, the insert may be replaced and the fastening screw and tool shank re-assembled. The need for sharpening or honing of tool blanks may be greatly reduced or eliminated by use of various embodiments of the invention.

### BRIEF DESCRIPTION OF THE DRAWINGS

The present invention will hereinafter be described in conjunction with the following drawing figures, wherein like numerals denote like elements:

FIG. 1 is a top perspective exploded view of a woodturning tool according to an embodiment of the invention;

FIGS. 2 (a)-(d) are top plan views of cutting inserts according to certain embodiments of the invention;

FIG. 3 (a)-(b) are several views of an exemplary cutting insert showing a number of cutting edges or cutting surfaces that may be defined in the cutting insert according to various embodiments of the invention;

FIG. 4 is a perspective view of a cutting insert according to an embodiment of the invention;

FIGS. 5 (a) and (b) illustrate alternate means of indexing an insert according to embodiments of the invention; and

FIG. 6 is a perspective view of a tool shank for a woodturning tool in accordance with an alternate embodiment of the invention.

### DETAILED DESCRIPTION

The following detailed description should be read with reference to the drawings, in which like elements in different drawings are numbered identically. The drawings depict selected embodiments and are not intended to limit the scope of the invention. It will be understood that embodiments shown in the drawings and described below are merely for illustrative purposes, and are not intended to limit the scope of the invention as defined in the claims.

The woodturning tools according to various embodiments of the invention include a replaceable, indexable, carbide cutting insert (or a cutting insert having one or more carbide cutting surfaces or tips), which improves the performance and longevity of a woodturning tool, while providing convenience to the operator.

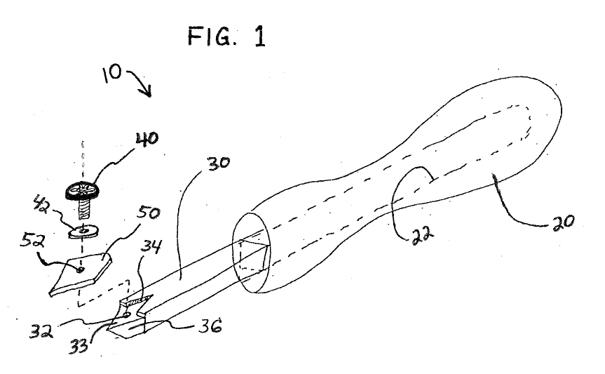

FIG. 1 is a top perspective view of a woodturning tool 10 according to various embodiments of the invention. As shown, tool 10 may have a generally longitudinal handle 20, which may be made of wood, or of other suitable materials having desired characteristics (e.g., strength, weight, etc.). Handle 20 may be shaped, for example, to provide a comfortable gripping or handling surface for holding in a woodturning operator's hands. In some embodiments, handle 20 may be shaped differently for right or left-handed operators, but this is not an essential aspect of the invention. Handle 20 may, in some embodiments, have a channel or an opening (such as recess 22) formed within in which to support and/or secure tool shank 30.

In certain embodiments, handle 20 may include a proximal portion, a central portion, and a distal portion. Recess 22 is formed in the distal portion of handle 20, and extends longitudinally toward the handle proximal end. Recess 22 may be adapted to conform to the proximal end of tool shank 30, for example, to provide a stable coupling between handle 20 and tool shank 30. In many embodiments, it may be desirable for recess 22 to include a cross-sectional shape that minimizes relative rotational movement between tool shank 30 and handle 20. For example, a square or triangular cross-sectional shape that conforms to a similarly-shaped shank proximal end will tend to reduce or minimize relative rotational movement between the handle 20 and the shank 30. Recess 22 may be substantially rectangular in cross-section, according to certain embodiments.

Handle 20 may also include a contoured outer surface, which facilitates hand-held use and operation of woodturning tool 10. For example, a contoured outer surface of handle 20 may be defined in part by the handle central portion being generally smaller in cross-sectional area than portions of the handle proximal and/or distal portions. More specifically, the handle central portion may have a minimum cross-sectional area that is smaller than a maximum cross-sectional area of the handle proximal portion. Similarly, the handle central portion may have a minimum cross-sectional area that is smaller than a maximum cross-sectional area of the handle distal portion.

Tool shank 30, shown in FIG. 1, is typically a longitudinal member having a proximal end and a distal end. Tool shank 30 may be adapted to be operatively coupled to handle 20. For example, the proximal end of tool shank 30 may be sized and shaped to achieve a compression fit, or other suitable coupling mechanism, within recess 22 of handle 30 in certain embodiments of the invention. Tool shank 30, when coupled to handle 20, extends longitudinally from handle 20 to provide an exposed portion adapted to receive a cutting insert 50, as shown in FIG. 1. Tool shank 30 may be formed of metal (e.g., steel), and may be shaped to include rounded and/or angled surfaces, depending on the intended application, for example. In some embodiments, the shank may be ¼, ⅜, or ½ round or square in cross-sectional shape, for example without limitation.

Tool shank 30 may include a shaped portion 36 at or near the shank distal end, the shaped portion adapted for a certain type of cutting or shaping process. The shaped portion 36 may further include a landing surface 33 and one or more sidewalls 34 near the shank's distal end adapted to receive an insert 50. In preferred embodiments, the shaped portion 36 may be shaped to substantially match the shape of insert 50 to provide a stable mounting arrangement. In some embodiments, the shaped portion 36 may comprise first and second sidewalls 34 that together form a shaped edge to the landing surface 33, which may provide a stable mounting arrangement for mating the cutting insert 50 with tool shank 30. The stability of this mounting arrangement may be enhanced, for example, in embodiments where the sidewalls 34 substantially conform to a portion of cutting insert 50. In some embodiments, the shaped edge formed by first and second sidewalls 34 may be substantially “V”-shaped to conform to certain cutting inserts. Shank 30 may further include threaded aperture 32 disposed in the landing surface 33 of the shaped portion 36, the threaded aperture being adapted to receive a fastening screw 40 placed through opening 52 in cutting insert 50, for holding insert 50 to shank 30. In certain embodiments, fastening screw 40 may be used in conjunction with washer 42 to provide additional support for securing cutting insert 50 to shank 30. In some preferred embodiments, fastening screw 40 may have a hexalobular internal driving feature (i.e., an internal star-shaped head), such as found in Torx® brand screws.

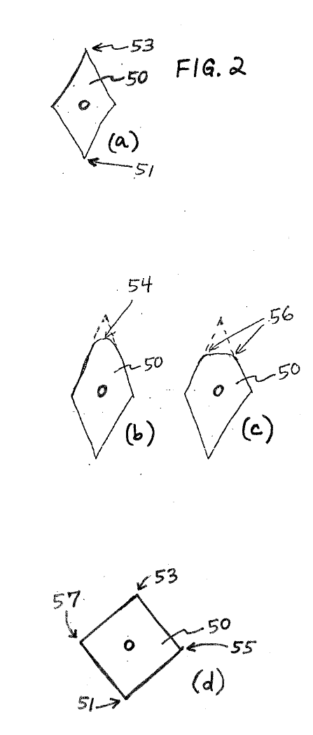

FIGS. 2 (a)-(d) show top plan views of insert 50 according to certain embodiments of the invention. FIG. 2(a), for example, shows an insert 50 having substantially symmetrical shaped cutting surfaces 51 and 53. Thus, while cutting surface 51 is made available for use in woodturning, cutting surface 53 mates with (e.g., conforms to the shape of) shaped portion 36 of tool shank 30 (see FIG. 1). In use, the insert 50 of FIG. 2(a) may be indexed (i.e., rotated to provide a different cutting edge or surface) when cutting surface 51 has worn down sufficiently, for example, by removing the fastening screw 40 of tool 10 (FIG. 1) and rotating insert 50 approximately 180 degrees. Cutting surface 53, having a substantially similar type of cutting surface as surface 51, can be used to continue a given operation, without having to re-sharpen any part of the tool 10. After indexing the insert 50, cutting surface 53 is now available for woodturning, while cutting surface 51 now mates with the shaped portion 36 of tool shank 30. (FIG. 1).

FIGS. 2 (b) and (c) show alternate embodiments of cutting insert 50 which may provide the ability to index the insert 50 in order to present a different type of cutting edge or surface for a different type of woodturning operation, for example. FIG. 2 (b) shows an insert 50 with a single rounded edge 54. FIG. 2 (c) shows an insert 50 with two rounded edges 56. In some embodiments, the two rounded edges 56 of FIG. 2 (c) need not be the same, providing potentially even more flexibility to an operator. The rounded edges 54 and 56 may include a variety of shapes and sizes. In some embodiments, edges 54 and 56 may be substantially circular, being defined by a radial dimension, for example. In some embodiments, a radial dimension of edges 54 and 56 may include ½″, ⅜″, and ¼″ radii, and may further include edges with increments of 1/64″ or 1/32″ in radius therebetween.

FIG. 2 (d) is a plan view of an alternate embodiment of cutting insert 50. The embodiment of FIG. 2 (d) is a cutting insert 50 having more than two cutting surfaces available. For example, the particular embodiment illustrated in FIG. 2 (d) includes four cutting surfaces 51, 53, 55, and 57. Such an embodiment may be indexable by rotating the cutting insert 50 in increments of about 90 degrees, for example. Of course, minor variations of this embodiment are contemplated, such as using different numbers of cutting surfaces or having different types of cutting surfaces, and such variations would be deemed to fall within the scope of the invention as claimed herein.

In some embodiments of the invention, the cutting inserts 50 may be described using terminology from metalworking or machining industries. Such descriptions may include, but are not limited to the following: RCMT 32, RCMT 43, DCMT 21.5, CCMT 21.5, and VBMT 21.5. These descriptions may provide a shorthand way to describe the overall shape of the cutting inserts, as well as the angles of the cutting surfaces on such inserts.

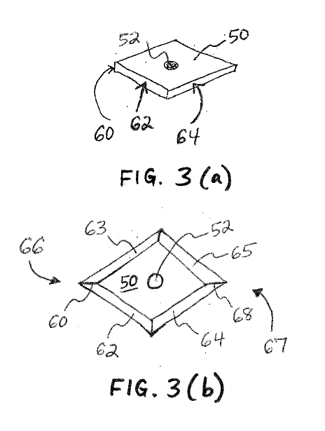

FIG. 3 (a) shows a side perspective view of insert 50 showing a number of edges 60, 62, 64 that may define one or more cutting surfaces in insert 50. In some embodiments, edge 60 (i.e., the front-most cutting surface) may have an angle defined therein, typically to provide clearance for cutting operations. The angle may range generally from about 5 to 15 degrees from vertical, and in more preferred embodiments of the invention, the angle of edge 60 may range from about 7 to 11 degrees from vertical. Similarly, edges 62 and 64 may have an angle defined therein according to certain embodiments, the angles also ranging from 7 to 11 degrees from vertical.

FIG. 3 (b) is a top plan view of exemplary cutting insert 50, showing edges 60, 62, and 63, which collectively form a first cutting surface 66. Similarly, FIG. 3 (b) shows edges 64, 65, and 68, which form a second cutting surface 67. As noted above, a woodturning operator may index the cutting insert 50 by rotating it (e.g., approximately 180 degrees about opening 52) to present a different cutting surface to a wooden workpiece. This may be done either because a first cutting surface becomes worn (e.g., in embodiments where the first and second cutting surfaces are of a substantially similar type), or because a different type of cutting surface is needed for a particular woodturning operation (e.g., in embodiments where the first and second cutting surfaces are of a different type).

FIG. 4 illustrates an alternate embodiment of the invention in which insert 50 may be formed of a metal body portion 58 (e.g., steel), and may include carbide portions 70 forming carbide cutting surfaces. The carbide cutting surfaces may be shaped and angled to provide the desired cutting characteristics.

FIGS. 5 (a) and (b) illustrate alternate means of indexing an insert 50. In FIG. 5 (a), a preferred method of indexing insert 50 involves rotating insert 50 substantially 180 degrees (e.g., either clockwise or counter-clockwise, as indicated by “CW/CCW” in FIG. 5 (a)) to present a new cutting edge to a workpiece. For example, the cutting insert 50 is rotated in a plane that is substantially parallel to the landing surface 33 of tool shank 30 (FIG. 1), according to a preferred embodiment. FIG. 5 (b) shows an alternate method of indexing insert 50 which involves turning insert 50 over to present the opposite surface of insert 50. This method may or may not be suitable, depending on the particular cutting application and/or on the presence and nature of edges 60, 62, or 64 (FIG. 3), if applicable.

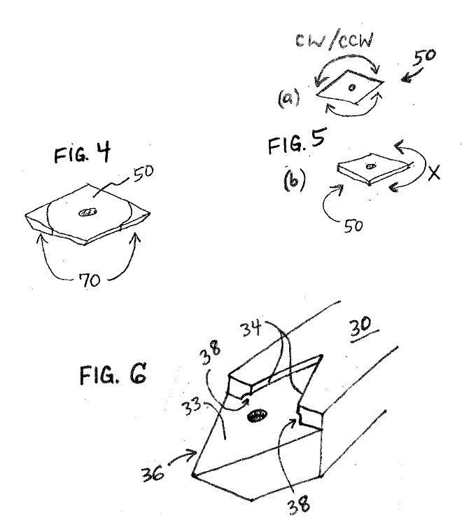

FIG. 6 is a perspective view of an alternate embodiment that may provide additional support for fastening a cutting insert to the tool shank 30. In the embodiment shown in FIG. 6, the shaped portion 36 of tool shank 30 has recessed portions 38 formed between sidewalls 34 and landing surface 33. Recessed portions 38 may facilitate mating of the cutting insert with the shaped portion 36 of tool shank 30, and may thereby provide additional support or stability to a cutting insert releasably fastened therewithin.

Various specific embodiments of the invention may include the following, all of which are deemed to fall within the scope of the appended claims:

1. Woodturning tool 10 having cutting insert 50 adapted for general purpose roughing and semi-finishing to size and shape. This tool may be a right handed tool, for example, by providing a suitable shape to handle 20 of tool 10.

2. Similar to above, except adapted for left-handed use.

3. Tool 10 having insert 50 adapted for blending radii and finishing cuts. This embodiment of tool 10 is adapted to produce a smooth finish to a wooden workpiece.

4. Tool 10 having insert 50 adapted for forming shallow groove widths, notches, etc., as ground on the insert.

5. Similar to 1 above, except the insert 50 may have a larger nose radius.

In certain embodiments of the invention, a woodturning system or kit may provide an operator the ability to readily switch between the above configurations and/or provide additional cutting configurations.

Thus, embodiments of a WOODTURNING TOOL are disclosed. One skilled in the art will appreciate that the present invention can be practiced with embodiments other than those disclosed. The disclosed embodiments are presented for purposes of illustration and not limitation.

What is claimed is:

1. A hand-held woodturning tool for use in shaping a wooden workpiece on a lathe, the tool comprising:
a longitudinal shank having a proximal end and a distal end;
a longitudinal handle having a recess adapted to receive the shank proximal end; and
a cutting insert adapted to be releasably fastened to the shank distal end, the cutting insert having two or more cutting surfaces comprising carbide, the cutting insert being adapted to be rotated with respect to the shank to change the cutting surface available for shaping wooden workpieces, the cutting insert being adapted to mate with a shaped portion of the shank distal end.

2. The woodturning tool of claim 1 wherein rotating the cutting insert causes a different type of cutting surface to be available for shaping wooden workpieces.

3. The woodturning tool of claim 1 wherein rotating the cutting insert causes a substantially similar type of cutting surface to be available for shaping wooden workpieces.

4. The woodturning tool of claim 3 wherein the type of cutting surface available is selected from the list consisting of skew, scraper, chisel, gouge, rounded, and pointed tip.

5. The woodturning tool of claim 1 wherein the cutting insert comprises a metal body portion and carbide cutting surfaces.

6. The woodturning tool of claim 3 wherein the cutting insert is adapted to be rotated about 180 degrees.

7. The woodturning tool of claim 1 wherein the shaped portion of the shank distal end includes a landing surface and a first sidewall.

8. The woodturning tool of claim 7 wherein the shaped portion further includes a second sidewall, the first and second sidewalls forming a shaped edge for mating with the cutting insert.

9. The woodturning tool of claim 8 wherein the shaped edge formed by the first and second sidewalls is substantially V-shaped.

10. The woodturning tool of claim 8 wherein the sidewalls further include a recessed portion to facilitate mating of the cutting insert with the shaped portion of the shank.

11. The woodturning tool of claim 1 further comprising a screw for releasably fastening the cutting insert to the shank distal end, the shank having a threaded aperture adapted to receive the screw.

12. The woodturning tool of claim 11 wherein the screw is a Torx® screw, and wherein the threaded aperture is disposed in a landing surface of the shaped portion of the shank distal end.

13. The woodturning tool of claim 1 wherein the handle has a proximal portion, a central portion, and a distal portion, the handle recess being formed in the handle distal portion and extending longitudinally toward the handle proximal end.

14. The woodturning tool of claim 13 wherein the handle recess is substantially rectangular in cross-section.

15. The woodturning tool of claim 13 wherein the handle recess is adapted to conform to the shank proximal end.

16. The woodturning tool of claim 15 wherein the handle recess includes a cross-sectional shape adapted to minimize relative rotational movement between the shank and the handle.

17. The woodturning tool of claim 13 wherein the handle includes a contoured outer surface to facilitate hand-held use.

18. The woodturning tool of claim 17 wherein the contoured outer surface of the handle is at least partially defined by the handle central portion having a minimum cross-sectional area that is smaller than a maximum cross-sectional area of the handle proximal portion.

19. The woodturning tool of claim 18 wherein the contoured outer surface of the handle is further defined by the handle central portion having a minimum cross-sectional area that is smaller than a maximum cross-sectional area of the handle distal portion.

20. The woodturning tool of claim 1 wherein the cutting insert is adapted to be replaced.

21. A method of shaping a wooden workpiece on a lathe, the method comprising:
providing a wooden workpiece adapted to turn on a lathe;
providing a hand-held woodturning tool, the tool comprising
a longitudinal shank having a proximal end and a distal end;
a longitudinal handle having a recess adapted to receive the shank proximal end; and
a cutting insert adapted to be releasably fastened to the shank distal end, the cutting insert having two or more cutting surfaces comprising carbide, the cutting insert being adapted to be rotated with respect to the shank to change the cutting surface available for shaping wooden workpieces, the cutting insert being adapted to mate with a shaped portion of the shank distal end;
releasing the insert from the shank;
rotating the insert to make available a new cutting surface;
securing the insert to the shank; and
using the woodturning tool to shape the wooden workpiece.
